(19) United States
(12) Patent Application Publication
(10) Pub. No.: US 2014/0330777 A1
(43) Pub. Date: Nov. 6, 2014

(54) APPARATUS AND METHOD FOR SYNCHRONIZING DATA

(71) Applicant: Samsung Electronics Co., Ltd., Gyeonggi-do (KR)

(72) Inventor: Grzegorz Pawel GRZESIAK, Warsaw (PL)

(73) Assignee: Samsung Electronics Co., Ltd., Gyeonggi-do (KR)

(21) Appl. No.: 14/269,711

(22) Filed: May 5, 2014

(30) Foreign Application Priority Data
May 3, 2013 (KR) 10-2013-0049935

(51) Int. Cl. G06F 17/30

(52) U.S. Cl. CPC G06F 17/30575
USPC 707/610

(57) ABSTRACT

An apparatus for synchronizing data in a terminal is provided. The apparatus includes a memory including an integrated Database (DB) that stores data of each of a plurality of DBs and a new integrated Identifier (ID) obtained by changing a local ID of the data; and a controller configured to transmit data having an integrated ID in the integrated DB to a server upon request for data synchronization with the server, thereby performing data synchronization.

### PRIORITY

This application claims priority under 35 U.S.C. §119(a) to a Korean Patent Application filed in the Korean Intellectual Property Office on May 3, 2013 and assigned Serial No. 10-2013-0049935, the entire disclosure of which is incorporated herein by reference.

### BACKGROUND OF THE INVENTION

1. Field of the Invention

The present invention generally relates to an apparatus and method for synchronizing data, and more particularly, to a data synchronization apparatus and method for performing data synchronization between a plurality of Databases (DBs) of a terminal and one DB of a server.

2. Description of the Related Art

Client-server data synchronization refers to data synchronization between two or more different DBs.

In a typical mobile device, a client has a predetermined number of DBs such as a phonebook, a calendar, a task list, and the like. In order for the client to perform data synchronization with a server using Synchronization Markup Language (SyncML), which is one of the most typical standards, the server needs to define the same DBs as those of the client. For example, phonebook data stored in a phonebook DB of the client is stored in a phonebook DB of the server.

However, if the client has two DBs (for example, a phonebook 1 and a phonebook 2), data synchronization between the two DBs of the client and the single DB of the server may suffer from an inconsistency problem, so the user needs to select one of the two DBs of the client, for which he or she wants to perform data synchronization with the single DB of the server.

For example, the client may have a Subscriber Identification Module (SIM) card and an internal memory. The SIM card, as a first DB, may store data record_{—}1_db1, record_{—}2_db1 and record_{—}3_db1, and the data record_{—}1_db1, record_{—}2_db1 and record_{—}3_db1 may have unique local Identifiers (IDs) 1, 2 and 3, respectively. The internal memory, as a second DB, may store data record_{—}1_db2 and record_{—}2_db2, and the data record_{—}1_db2 and record_{—}2_db2 may have unique local IDs 1 and 2, respectively. In this case, if data synchronization is performed between the two DBs of the client and the single DB of the server, two data corresponding to the same local ID 1 may be written in the single DB of the server in a duplicated manner and two data corresponding to the same local ID 2 may also be written in the single DB of the server in a duplicated manner, causing data collision.

If record_{—}1_db1 having a local ID 1 is changed in the single DB of the server and then the server transmits the changed record_{—}1_db1 having the local ID 1 to the client, the client may not determine with the local ID 1 whether the changed data is record_{—}1_db1 in the first DB or record_{—}1_db2 in the second DB.

For this reason, therefore, the client needs to undesirably select any one of its plurality of DBs, and perform data synchronization between the selected DB and the single DB of the server.

### SUMMARY OF THE INVENTION

An aspect of the present invention is to address at least the above-mentioned problems and/or disadvantages and to provide at least the advantages described below.

Accordingly, an aspect of the present invention is to provide a data synchronization apparatus and method for performing data synchronization between a plurality of Databases (DBs) of a terminal and one DB of a server without data collision.

Another aspect of the present invention is to provide a data synchronization apparatus and method for performing data synchronization between a plurality of DBs of a terminal and one DB of a server without duplicate data entry.

In accordance with an aspect of the present invention, an apparatus for synchronizing data in a terminal is provided. The apparatus includes a memory including an integrated Database (DB) that stores data of each of a plurality of DBs and a new integrated Identifier (ID) obtained by changing a local ID of the data; and a controller configured to transmit data having an integrated ID in the integrated DB to a server upon request for data synchronization with the server, thereby performing data synchronization.

In accordance with another aspect of the present invention, a method for synchronizing data in a terminal is provided. The method includes configuring an integrated Database (DB) that stores data of each of a plurality of DBs and a new integrated Identifier (ID) obtained by changing a local ID of the data; and transmitting data having an integrated ID in the integrated DB to a server upon request for data synchronization with the server, thereby performing data synchronization.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 illustrates a structure of a terminal according to an embodiment of the present invention;

FIG. 2 is a flowchart illustrating a data synchronization operation in a terminal with a server in a terminal according to an embodiment of the present invention;

FIG. 3 illustrates an integrated DB of a terminal according to an embodiment of the present invention;

FIG. 4 illustrates an integrated DB of a terminal according to an embodiment of the present invention;

FIGS. 5A and 5B illustrate an integrated DB in a terminal according to embodiments of the present invention; and

FIG. 6 is a flowchart illustrating a data synchronization operation in a terminal with a server according to an embodiment of the present invention.

Throughout the drawings, like reference numerals will be understood to refer to like parts, components, and structures.

### DETAILED DESCRIPTION OF EMBODIMENTS OF THE PRESENT INVENTION

The following description with reference to the accompanying drawings is provided to assist in a comprehensive understanding of embodiments of the present invention as defined by the claims and their equivalents. It includes various specific details to assist in that understanding but these are to be regarded as merely examples. Accordingly, those of ordinary skilled in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to their dictionary meanings, but, are merely used to enable a clear and consistent understanding of the invention. Accordingly, it should be apparent to those skilled in the art that the following description of embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Terminals, to which embodiments of the present invention are applicable, may include mobile terminals and fixed terminals. The mobile terminals, easy-to-carry portable electronic devices, may include video phones, cellular phones, smart phones, Wideband Code Division Multiple Access (WCDMA) terminals, Universal Mobile Telecommunication Service (UMTS) terminals, Personal Digital Assistants (PDAs), Portable Multimedia Players (PMPs), Digital Multimedia Broadcasting (DMB) terminals, E-Book readers, portable computers (for example, laptop computers, tablet computers and the like), digital cameras and the like. The fixed terminals may include desktop Personal Computers (PCs) and the like.

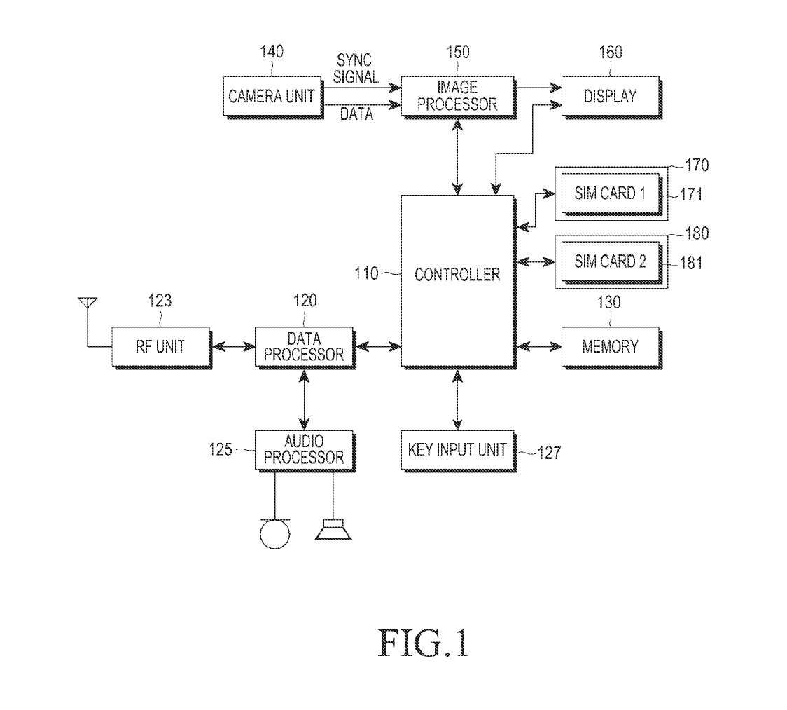

FIG. 1 illustrates a structure of a terminal according to an embodiment of the present invention.

Referring to FIG. 1, a Radio Frequency (RF) unit 123 is responsible for wireless communication of the terminal. The RF unit 123 includes an RF transmitter for up-converting a frequency of transmission signals and amplifying the up-converted transmission signals, and an RF receiver for low-noise-amplifying received signals and down-converting a frequency of the amplified received signals. A data processor 120 includes a transmitter for coding and modulating the transmission signals, and a receiver for demodulating and decoding the received signals. In other words, the data processor 120 may be comprised of a modulator-demodulator (modem) and a coder-decoder (codec). The codec includes a data codec for processing packet data and the like, and an audio codec for processing audio signals such as voice. An audio processor 125 plays received audio signals output from the audio codec in the data processor 120, using a speaker, and transfers transmission audio signals picked up by a microphone to the audio codec in the data processor 120.

A key input unit 127 includes numeric/character keys for allowing a user to enter numeric and character information, and function keys for setting various functions.

A memory 130 may be comprised of a program memory and a data memory. The program memory may store programs for controlling the overall operation of the terminal, and programs for synchronizing data stored in a single integrated DB configured by integrating a plurality of DBs of the terminal with data in a single DB of a server. The data memory may temporarily store the data generated during execution of the programs.

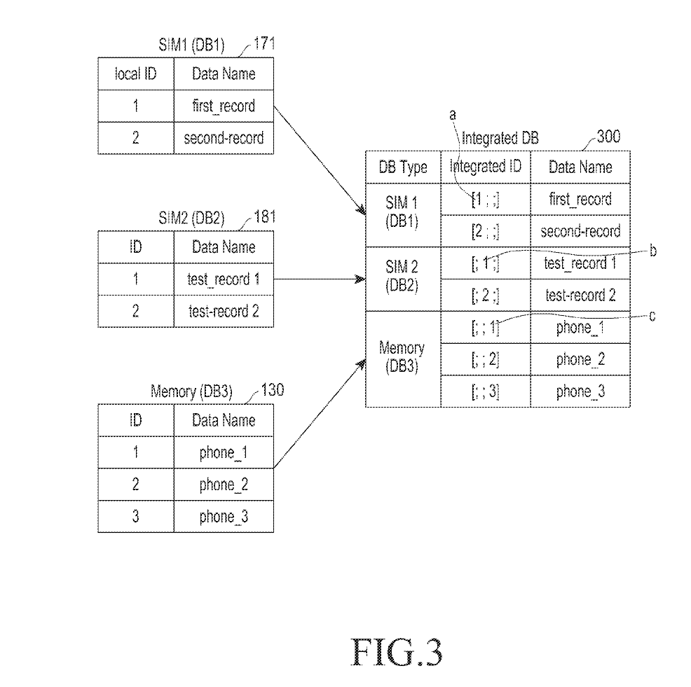

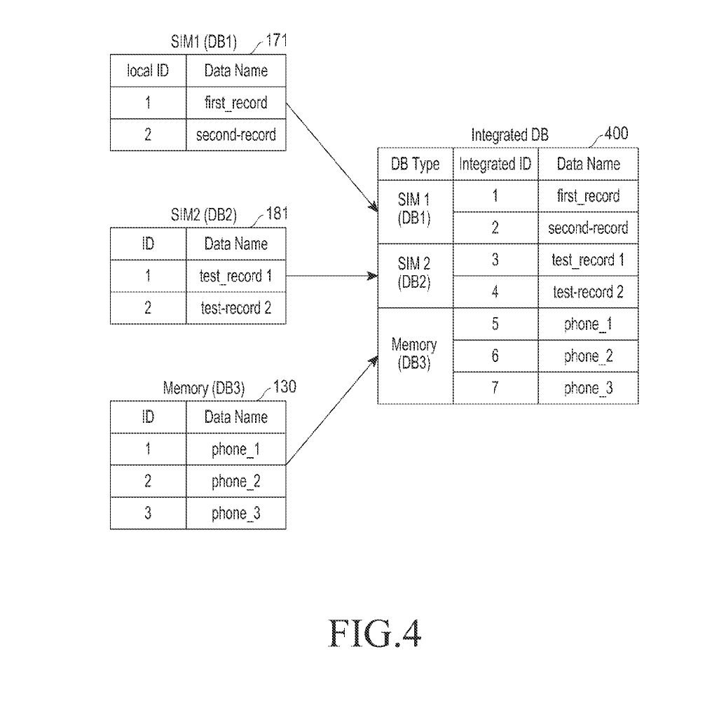

In accordance with embodiments of the present invention, the memory 130 stores a single integrated DB configured by integrating a plurality of DBs. The integrated DB stores multiple data of each of the plurality of DBs and new integrated Identifiers (IDs) determined by changing local IDs of the multiple data. The integrated DB will be described in detail below with reference to FIGS. 3 and 4.

A first Subscriber Identification Module (SIM) card SIM1 171 may be inserted into a first SIM card socket 170, and a second SIM card SIM2 181 may be inserted into a second SIM card socket 180.

In accordance with embodiments of the present invention, the first and second SIM cards 171 and 181 will be assumed as first and second DBs, respectively, and the memory 130 will be assumed as a third DB. Although three DBs will be considered in embodiments of the present invention, the number of DBs is subject to change. The memory 130 may be classified into a DB for storing data corresponding to a phonebook application, a DB for storing data corresponding to a calendar application, and a DB for storing data corresponding to a camera application.

A controller 110 controls the overall operation of the terminal.

In accordance with embodiments of the present invention, upon a request for data synchronization with a server, the controller 110 may create one integrated DB configured by integrating the first, second and third DBs 171, 181 and 130.

Alternatively, before requesting data synchronization with a server, the controller 110 may create one integrated DB configured by integrating the first, second and third DBs 171, 181 and 130.

The controller 110 stores, in the integrated DB, multiple data stored in each of the first, second and third DBs 171, 181 and 130, and integrated IDs corresponding to the multiple data. As to the integrated IDs, the controller 110 changes local IDs of the multiple data stored in each DB to new integrated IDs.

The controller 110 may create the integrated IDs by delimiting locations corresponding to the first, second and third DBs 171, 181 and 130 using delimiters, and writing local IDs of multiple data stored in a specific DB in a specific location among the delimited locations.

The controller 110 may create the integrated DB by delimiting three locations corresponding to the first, second and third DBs 171, 181 and 130 using the delimiters, writing local IDs of multiple data stored in the first DB 171 in a first location, writing local IDs of multiple data stored in the second DB 181 in a second location, and writing local IDs of multiple data stored in the third DB 130 in a third location.

If local IDs of multiple data stored in each of the first, second and third DBs 171, 181 and 130 are each written as a number, the controller 110 may create the integrated IDs by sequentially writing intact local IDs of multiple data stored in the first DB 171, and changing (or shifting) local IDs of multiple data stored in the second and third DBs 181 and 130 by an offset. For example, if ten data are stored in each of the first, second and third DBs 171, 181 and 130, the controller 110 may change local IDs 1 to 10 corresponding to ten data stored in the first DB 171 to integrated IDs 1 to 10, change local IDs 1 to 10 corresponding to ten data stored in the second DB 181 to integrated IDs 11 to 20, and change local IDs 1 to 10 corresponding to ten data stored in the third DB 130 to integrated IDs 21 to 30.

Upon receiving changed data from the server, the controller 110 may detect an ID of the received data from the integrated DB, and replace data corresponding to the detected ID with the changed data received from the server in the integrated DB.

In accordance with embodiments of the present invention, the server may include a single DB, in which multiple data and their integrated IDs may be stored to be the same as those stored in the integrated DB of the terminal.

A camera unit 140 includes a camera sensor for capturing image data and converting the captured optical image signals into electrical image signals, and a signal processor for converting analog image signals captured by the camera sensor into digital image data. The camera sensor may be a Charge-Coupled Device (CCD) or Complementary Metal-Oxide Semiconductor (CMOS) sensor, and the signal processor may be implemented with a Digital Signal Processor (DSP). The camera sensor and the signal processor may be implemented either integrally or separately.

An image processor 150 performs Image Signal Processing (ISP) to display the image signals output from the camera unit 140 on a display 160. The ISP may include functions such as gamma correction, interpolation, spatial variation, image effects, image scaling, Automatic White Balance (AWB), Automatic Exposure (AE), Automatic Focus (AF) and the like. The image processor 150 handles the image signals output from the camera unit 140 on a frame basis, and outputs frame image data to match with the characteristics and size of the display 160. The image processor 150, which includes a video codec, may compress frame image data display on the display 160 and decompress the compressed frame image data into its original frame image data, using a predetermined coding/decoding scheme. The video codec may be a Joint Photographic Experts Group (JPEG) codec, a Moving Picture Experts Group 4 (MPEG4) codec, a Wavelet codec, or the like. The image processor 150 is assumed to have an On-Screen Display (OSD) function, and may output OSD data depending on the size of the display screen, under control of the controller 110.

The display 160 displays, on its screen, the image signals output from the image processor 150 and the user data output from the controller 110. A Liquid Crystal Display (LCD) may be used as the display 160. In this case, the display 160 may include an LCD controller, a video memory capable of storing image data, and an LCD panel. When implemented as a touch screen, the LCD may also serve as an input unit. In this case, the same keys as those on the key input unit 127 may be displayed on the display 160.

If the display 160 is used as a touch screen unit when it is implemented as a touch screen, the touch screen unit may be comprised of a Touch Screen Panel (TSP) including a plurality of sensor panels. The plurality of sensor panels may include a capacitive sensor panel capable of detecting fingertip touches, and an electromagnetic induction sensor panel capable of detecting fine touches such as touches by a stylus pen.

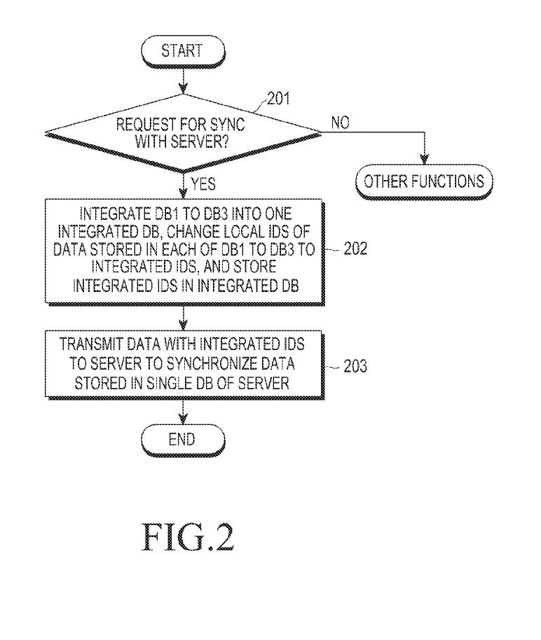

The data synchronization operation performed in the above-described terminal will be described in detail with reference to FIGS. 2 to 6.

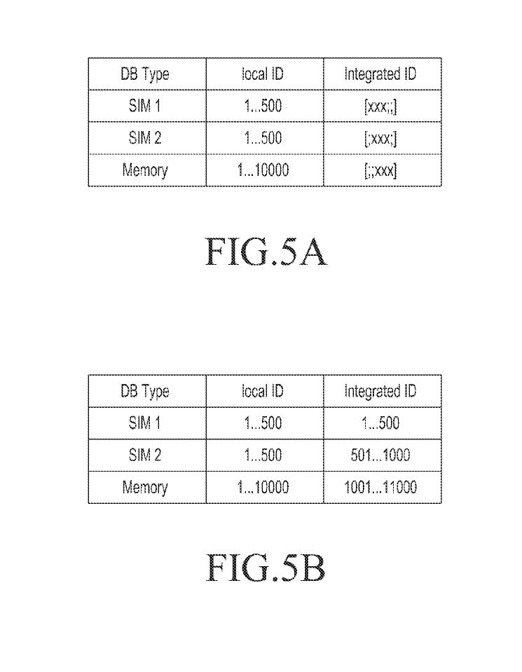

FIG. 2 is a flowchart illustrating a data synchronization operation in a terminal with a server according to an embodiment of the present invention, FIG. 3 illustrates an integrated DB of a terminal according to the embodiment of the present invention, FIG. 4 illustrates an integrated DB of a terminal according to another embodiment of the present invention, and FIGS. 5A and 5B illustrate an integrated DB in a terminal according to embodiments of the present invention.

The data synchronization operation will now be described in detail below with reference to FIGS. 1 to 5.

Referring to FIG. 2, upon request in the terminal for data synchronization with the server, the controller 110 detects the request for data synchronization in step 201, and integrates the first, second and third DBs 171, 181 and 130 of the terminal into one integrated DB and changes local IDs of multiple data stored in each of the first, second and third DBs 171, 181 and 130 to integrated IDs in the integrated DB, in step 202.

Referring to FIGS. 3 to 5B, creation of the integrated DB will be described. As illustrated in FIG. 3, if the first, second and third DBs 171, 181 and 130 are integrated into one integrated DB 300, the controller 110 delimits three locations using delimiters ‘;’ ([first location ‘a’; second location ‘b’; third location ‘c’]). The controller 110 may create new integrated IDs [1; ;] and [2; ;] by writing local IDs only for multiple data first record and second record of the first DB 171 in the first location ‘a’. The controller 110 may create new integrated IDs [;1;] and [;2;] by writing local IDs only for multiple data test record1 and test record2 of the second DB 181 in the second location ‘b’. The controller 110 may create new integrated IDs [; ;1], [; ;2] and [; ;3] by writing local IDs for multiple data phone_{—}1, phone_{—}2 and phone_{—}3 of the third DB 130 in the third location ‘c’.

Although it is assumed in FIG. 3 that each local ID is expressed as a number, it will be apparent to those of ordinary skill in the art that as illustrated in FIG. 5A, the number of integrated IDs written in a specific location among a plurality of locations delimited by delimiters is subject to change, and the integrated IDs may be written as various types of characters or numbers.

Next, as illustrated in FIG. 4, if the first, second and third DBs 171, 181 and 130 are integrated into one integrated DB 400, the controller 110 may sequentially create integrated IDs 1 and 2 using local IDs 1 and 2 for multiple data first_record and second_record stored in the first DB 171. The controller 110 may create integrated IDs 3 and 4 by changing (or shifting) local IDs 1 and 2 for multiple data test_record1 and test_record2 stored in the second DB 181 by an offset. The controller 110 may create integrated IDs 5 to 7 by changing local IDs 1 to 3 for multiple data phone_{—}1, phone_{—}2 and phone_{—}3 stored in the third DB 130 by an offset.

Although it is assumed in FIG. 4 that an integrated ID is expressed as a number, it will be apparent to those of ordinary skill in the art that as illustrated in FIG. 5B, the number of integrated IDs is subject to change and the integrated IDs may be created by changing local IDs by an offset.

Referring back to FIG. 2, after creating the integrated DB in step 202, the controller 110 transmits multiple data having the integrated IDs in the integrated DB to the server to store them in the single DB of the server, completing the data synchronization, in step 203.

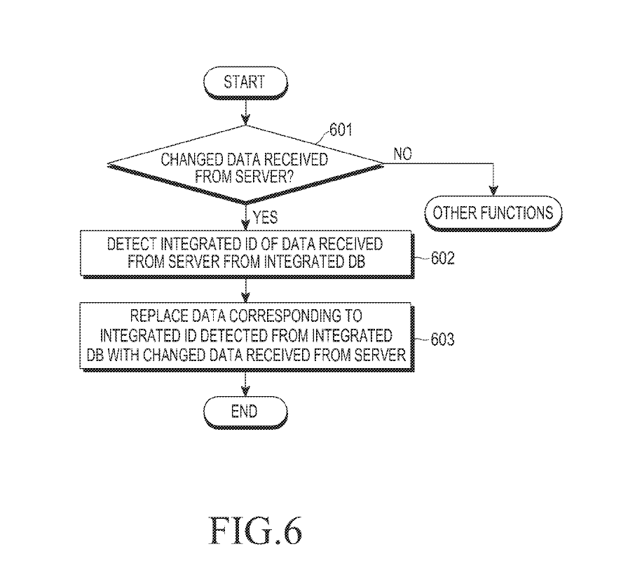

FIG. 6 is a flowchart illustrating a data synchronization operation in a terminal with a server according to the embodiment of the present invention.

The data synchronization operation will now be described in detail below with reference to FIGS. 1 and 6.

Referring to FIG. 6, if specific data is changed in the server's single DB, in which the same multiple data and integrated IDs as those in the integrated DB of the terminal are stored through the data synchronization operation in FIG. 2, the server transmits the changed data and its integrated ID to the terminal, for data synchronization.

Upon receiving the changed data from the server, the controller 110 detects the reception of the changed data in step 601, and detects an integrated ID of the received data from the integrated DB, in step 602.

In step 603, the controller 110 replaces the data corresponding to the detected integrated ID with the changed data received from the server in the integrated DB, completing the data synchronization.

The embodiments of the present invention may be implemented as computer-readable codes in computer-readable recording media. The computer-readable recording media may include all kinds of recording devices that store computer-readable data. Typical examples of the recording media may include Read Only Memory (ROM), Random Access Memory (RAM), optical discs, magnetic tapes, floppy discs, hard discs, non-volatile memories and the like, and may also include recording media implemented in the form of carrier waves (for example, transmission over the Internet). The computer-readable recording media may be distributed over computer systems connected by a network, and the computer-readable codes may be stored and executed in a distributed manner.

As is apparent from the foregoing description, the data synchronization apparatus and method of the present invention may freely perform data synchronization between a plurality of DBs of the terminal and one DB of the server without data collision and/or duplicate data entry.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. An apparatus for synchronizing data in a terminal, the apparatus comprising:
a memory including an integrated Database (DB) that stores data of each of a plurality of DBs and a new integrated Identifier (ID) obtained by changing a local ID of the data; and
a controller configured to transmit data having the integrated ID in the integrated DB to a server upon request for data synchronization with the server, thereby performing data synchronization.

2. The apparatus of claim 1, wherein the controller configures the integrated DB upon a request for data synchronization with the server.

3. The apparatus of claim 1, wherein the controller configures the integrated DB before a request for data synchronization with the server.

4. The apparatus of claim 1, wherein the controller is configured to create the integrated ID by delimiting locations, which correspond in number to the plurality of DBs, using delimiters, and writing a local ID of data stored in a specific DB in a specific location among the delimited locations.

5. The apparatus of claim 4, wherein if the plurality of DBs include first to third DBs, the controller is configured to create the integrated DB by delimiting three locations using the delimiters, writing a local ID of data stored in the first DB in a first location, writing a local ID of data stored in the second DB in a second location, and writing a local ID of data stored in the third DB in a third location.

6. The apparatus of claim 1, wherein if the local ID is written as a number, the controller is configured to create the integrated ID by writing an intact local ID of data stored in some of the plurality of DBs and changing a local ID of data stored in other DBs by an offset.

7. The apparatus of claim 6, wherein if the plurality of DBs include first to third DBs and the data stored in each of the first to third DBs include ten data, the controller is configured to change first to tenth local IDs corresponding to the ten data stored in the first DB to first to tenth integrated IDs, change first to tenth local IDs corresponding to ten data stored in the second DB to eleventh to twentieth integrated IDs, and change first to tenth local IDs corresponding to the ten data stored in the third DB to twenty-first to thirtieth integrated IDs.

8. The apparatus of claim 1, wherein upon receiving changed data from the server, the controller is configured to detect an ID of the received data from the integrated DB, and replace data corresponding to the detected ID with the changed data received from the server in the integrated DB.

9. The apparatus of claim 1, wherein data and an integrated ID corresponding thereto, which are stored the integrated DB, are the same as those stored in a single DB of the server.

10. A method for synchronizing data in a terminal, the method comprising:
configuring an integrated Database (DB) that stores data of each of a plurality of DBs and a new integrated Identifier (ID) obtained by changing a local ID of the data; and
transmitting data having the integrated ID in the integrated DB to a server upon request for data synchronization with the server, thereby performing data synchronization.

11. The method of claim 10, further comprising configuring the integrated DB upon a request for data synchronization with the server.

12. The method of claim 10, further comprising configuring the integrated DB before a request for data synchronization with the server.

13. The method of claim 10, further comprising creating the integrated ID by delimiting locations, which correspond in number to the plurality of DBs, using delimiters, and writing a local ID of data stored in a specific DB in a specific location among the delimited locations.

14. The method of claim 13, further comprising:
if the plurality of DBs include first to third DBs, creating the integrated DB by delimiting three locations using the delimiters, writing a local ID of data stored in the first DB in a first location, writing a local ID of data stored in the second DB in a second location, and writing a local ID of data stored in the third DB in a third location.

15. The method of claim 10, further comprising:
if the local ID is written as a number, creating the integrated ID by writing an intact local ID of data stored in some of the plurality of DBs and changing a local ID of data stored in other DBs by an offset.

16. The method of claim 15, further comprising:
if the plurality of DBs include first to third DBs and the data stored in each of the first to third DBs include ten data, changing first to tenth local IDs corresponding to the ten data stored in the first DB to first to tenth integrated IDs, changing first to tenth local IDs corresponding to the ten data stored in the second DB to eleventh to twentieth integrated IDs, and changing first to tenth local IDs corresponding to the ten data stored in the third DB to twenty-first to thirtieth integrated IDs.

17. The method of claim 10, further comprising:
upon receiving changed data from the server, detecting an ID of the received data from the integrated DB; and
replacing data corresponding to the detected ID with the changed data received from the server in the integrated DB.

18. The method of claim 10, wherein data and an integrated ID corresponding thereto, which are stored the integrated DB, are the same as those stored in a single DB of the server.
